(19) United States
(12) Patent Application Publication
(10) Pub. No.: US 2008/0168533 A1
(43) Pub. Date: Jul. 10, 2008

(54) PROGRAM VERIFICATION APPARATUS AND METHOD, AND SIGNATURE SYSTEM BASED ON PROGRAM VERIFICATION

(75) Inventors: Satoshi Ozaki, Kawasaki-shi (JP); Keiichi Teramoto, Kawasaki-shi (JP); Yoshiki Terashima, Kawasaki-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 11/958,024

(22) Filed: Dec. 17, 2007

(30) Foreign Application Priority Data
Dec. 21, 2006 (JP) 2006-344827

(51) Int. Cl. G06F 21/00

(52) U.S. Cl. 726/1

(57) ABSTRACT

A program verification apparatus includes a storing which stores a plurality of statements in correspondence with values of respective risk levels of the statements. Referring to a signature included in a signed module, a value indicating a risk level of the signed module is obtained. A to-be-verified program including a plurality of statements or signed modules is input to the apparatus. Values of first risk levels of the statements included in the to-be-verified program are determined by referring to the storing device. Values of second risk levels of the signed modules included in the to-be-verified program are also determined. Then, a maximum value of a risk level of the to-be-verified program is calculated from the values of the first risk levels and the values of the second risk levels. A verification result including the maximum value of the risk level is outputted accordingly.

### CROSS-REFERENCE TO RELATED APPLICATIONS

This application is based upon and claims the benefit of priority from prior Japanese Patent Application No. 2006-344827, filed Dec. 21, 2006, the entire contents of which are incorporated herein by reference.

### BACKGROUND OF THE INVENTION

1. Field of the Invention

The present invention relates to a program verification apparatus and method for suppressing effects caused by malware and computer viruses, and a signature system based on program verification.

2. Description of the Related Art

When a program is obtained through an unreliable communication route such as the Internet, it is required to verify whether the program is safe or not. For the purpose of helping verification, it is performed to distribute programs with electronic signatures to verify that the programs are correctly reached to the user's computers from the distributors (for example, refer to “Verisign Codesigning Certificate in A Program on Windows (registered trademark)”, URL:http://www.veridesign.co.jp/codesign/authenticode/message.html).

If the signature is correct, it is verified that a program with the signature is not tampered. Further, authority to perform the program can be limited according to presence/absence of signature, such as determining whether the program can access an important resource according to presence/absence of signature (for example, refer to “Java(registered trademark) security architecture” URL: http://java.sun.com/j2se/1.5.0/ja/docs/ja/guide/security/spec/security-spec.docl.html).

However, even when an electronic signature is provided to a program, it cannot be mechanically determined whether the program itself is harmful or not. Further, it is also difficult to uniformly determine whether to allow the program to access resources such as networks. This is because uniformly allowing access incurs the risk of performing undesirable programs, which causes the user's computers to be used for open proxy and botnet for transmission of spams. On the other hand, if access is uniformly rejected, it is impossible to perform programs utilizing services on networks, such as Web API.

As described above, the prior art has the problem that it cannot be mechanically determined whether the program itself is harmful or not. Further, it has the problem that it is difficult to uniformly determine whether access to resources such as networks is allowed or not.

### BRIEF SUMMARY OF THE INVENTION

A program verification apparatus according to an aspect of the present invention comprises: a storing device to store a plurality of statements in correspondence with values of respective risk levels of the statements; an obtaining device configured to refer to a signature included in a signed module, and thereby to obtain a value indicating a risk level of the signed module; an input device configured to input a to-be-verified program including a plurality of statements or signed modules; a calculating device configured to determine values of first risk levels of the statements included in the to-be-verified program by referring to the storing device, determine values of second risk levels of the signed modules included in the to-be-verified program by using the obtaining device, and calculate a maximum value of a risk level of the to-be-verified program from the values of the first risk levels and the values of the second risk levels; and an output device configured to output a verification result including the maximum value of the risk level.

A signature system according to another aspect of the present invention has the above program verification apparatus and comprises: a first input device configured to input a to-be-verified program; a first output device configured to output the to-be-verified program to the program verification apparatus; a second input device configured to input a verification result output from the program verification apparatus with respect to the to-be-verified program output by the first output device; a first generating device configured to generate signature information including the verification result input to the second input device; and a second generating device configured to generate a signed program by adding the signature information to the to-be-verified program input to the first input device.

### BRIEF DESCRIPTION OF THE SEVERAL VIEWS OF THE DRAWING

FIG. 1 is a block diagram illustrating a program execution system according to an embodiment.

FIG. 2 is a block diagram illustrating a verification apparatus of FIG. 1.

FIG. 3 is a flowchart illustrating operation of the verification apparatus.

FIG. 4 is a block diagram illustrating a signing apparatus of FIG. 1.

FIG. 5 is a block diagram illustrating a development apparatus of FIG. 1.

FIG. 6 is a block diagram illustrating a distribution apparatus of FIG. 1.

FIG. 7 is a block diagram illustrating a user apparatus in FIG. 1.

FIG. 8 is a diagram illustrating an example of a data structure of a signed program.

FIG. 9 is a diagram illustrating an example of a source code of a program to be verified.

FIG. 10 is a diagram illustrating an example of a source code of a signed module.

### DETAILED DESCRIPTION OF THE INVENTION

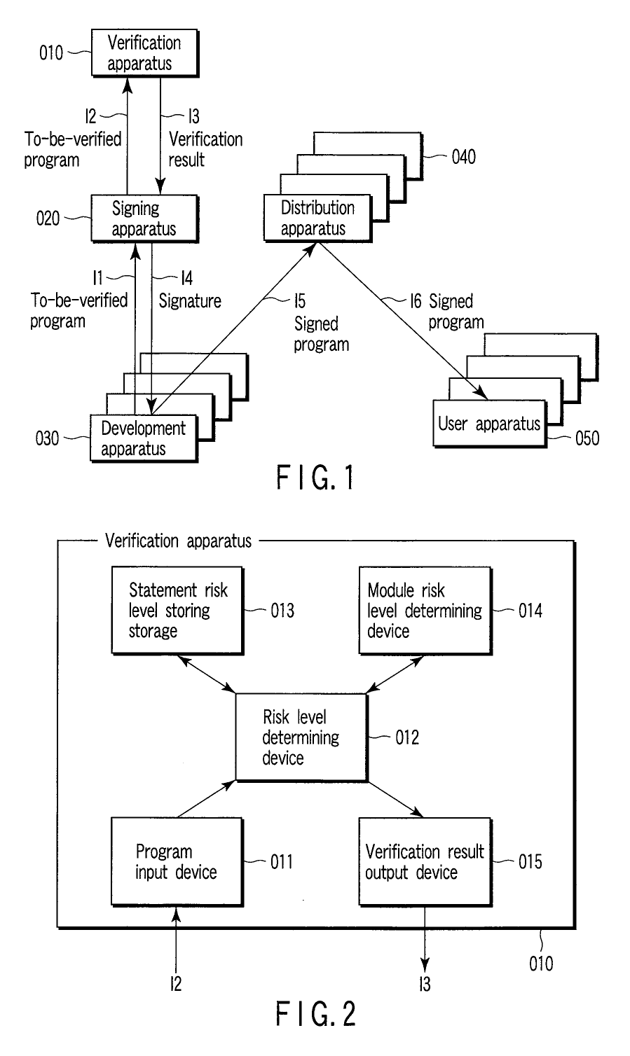

Referring now to FIG. 1, a program execution system according to an embodiment includes a verification apparatus 010 which verifies programs, a signing apparatus 020 which calculates signatures of programs, a development apparatus 030 which develops programs, a distribution apparatus 040 which distributes programs, and a user apparatus 50 which uses (executes) programs.

The signing apparatus 020 receives programs to be verified from the development apparatus 030, and assigns signatures to programs which have been (manually or mechanically) verified as safe programs, according to the risk levels thereof. Details of the operation are explained below. The signing apparatus 020 requests the verification apparatus 010 to calculate the risk level of a program to be verified. The verification apparatus 010 calculates the risk level of the program to be verified, on the basis of the risk level of the signed module thereof and predetermined risk levels of statements, and sends a verification result indicating the risk level of the program to be verified to the signing apparatus 020. On the basis of the verification result from the verification apparatus 010, the signing apparatus 020 assigns a signature to the program to be verified according to the risk level. The program provided with a signature (referred to as “signed program”) is distributed to the user apparatus 050 through the distribution apparatus 040. When a signed program is distributed, the user apparatus 050 authenticates that the program is provided with a valid signature and the risk level written in the signature does not exceed a predetermined executable risk level, and then executes the signed program.

A flow until a signed program is distributed to the user apparatus in the program execution system of the embodiment is explained with reference to FIG. 1. The developers develop a program by using the development apparatus 030. When development is completed, the development apparatus 030 sends the program I1 to the signing apparatus 020 to subject the program I1 to use in the user apparatus 050. The program is called “to-be-verified program”.

The signing apparatus 020 sends the to-be-verified program I1 received from the development apparatus 030 to the verification apparatus 010 as to-be-verified program I2 without any processing, and requests the verification apparatus 010 to verify the program. The verification apparatus 010 verifies the to-be-verified program I2 sent from the signing apparatus 020, and sends a verification result I3 to the signing apparatus 020. The verification result I3 includes information indicating a program risk level, and the signing apparatus 020 generates a signature I4 based on the verification result I3. The “program risk level” has a value representative of values of respective risk levels of statements or modules forming the to-be-verified program 12. The representative value is, for example, a maximum value of the values of the respective risk levels. The signing apparatus 020 transmits the signature I4 to the development apparatus 030.

The development apparatus 030 transmits a signed program I5, which corresponds to the to-be-verified program I1 having been verified and provided with a signature, to the distribution apparatus 040. The distribution apparatus 040 distributes the signed program I6 to the user apparatus 050. The user apparatus 050 authenticates that the signature attached to the signed program I6 is valid, and reads the program risk level from the signature information thereof. When the program risk level does not exceed a predetermined executable risk level, the user apparatus 050 executes the signed program I6. The program execution system according to the embodiment having the above structure allows the user apparatus 050 to mechanically determine whether executing the program causes any problem or not.

The following is explanation of the apparatuses forming the program execution system.

Referring to FIG. 2, the verification apparatus 010 includes a program input device 011 which inputs a program, a risk level determining device 012 which determines the program risk level, a statement risk level storage 013 which stores respective risk levels of statements forming programs, a module risk level determining device 014 which obtains respective risk levels of modules forming the program, and a verification result output device 015 which outputs a verification result of the program.

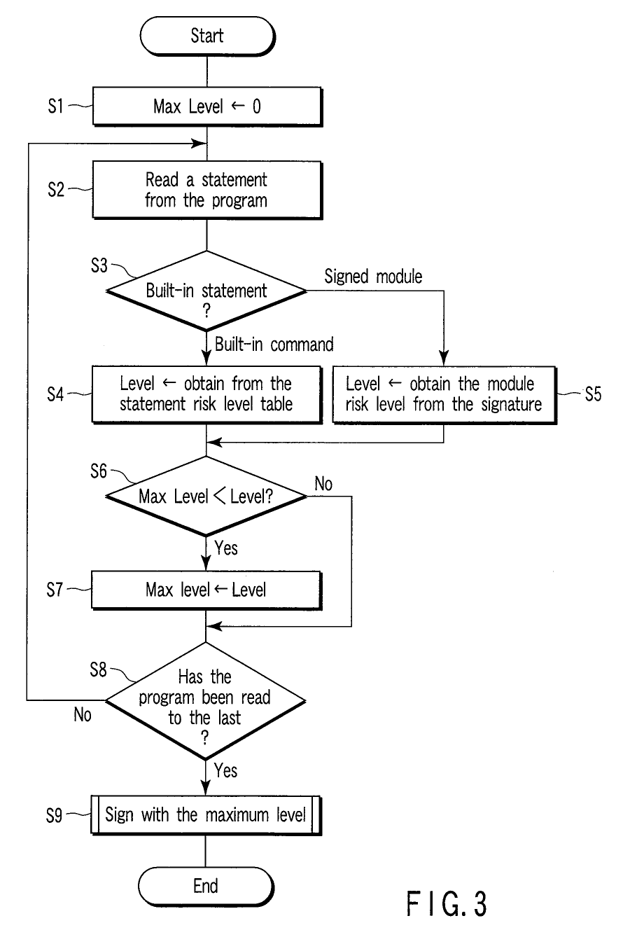

Operation of the verification apparatus 010 is explained with reference to FIGS. 2 and 3 and Table 1. FIG. 3 is a flowchart illustrating operation of the verification apparatus 010.

First, the risk level determining device 012 clears (resets) a variable “MaxLevel”, which indicates the maximum risk level (maximum value of the risk level), to 0 (step S1).

Next, the program input device 011 reads statements one by one from the to-be-verified program I2, and transmits the statements one by one to the risk level determining device 012 (step S2).

Then, the risk level determining device 012 determines whether each statement transmitted from the program input device 011 is a built-in statement or not (step S3). If a statement transmitted from the program input device 011 is a built-in statement, the risk level determining device 012 reads a risk level corresponding to the statement from the statement risk level storage 013, and stores the risk level as the variable “Level” (step S4). The statement risk level storage 013 stores in advance statement risk level data indicating correspondence between statements and their risk levels, as illustrated in Table 1, for example.

TABLE 1

| Statement | Risk value |
|---|---|
| if | 0 |
| for | 0 |
| strlcat | 1 |
| socket | 5 |
| connect | 5 |
| close | 1 |
| getaddrinfo | 1 |
| freeaddrinfo | 1 |
| printf | 0 |
| gets | 5 |
| strcat | 4 |
| return | 0 |
| . . . | . . . |

On the other hand, when the statement transmitted from the program input device 011 in step S3 is a signed module, the risk level determining device 012 transmits the module to the module risk level determining device 014, obtains a risk level corresponding to the module, and stores the risk level as the variable “Level” (step S5). In this step, the module risk level determining device 014 checks the signature assigned to the module, and obtains the value of the risk level by reading the risk level written in the signature. In the program execution system, the program is formed of built-in statements and signed modules, and no modules without signatures are supposed to be input to the verification apparatus 010. To use modules in the program execution system, it is necessary to determine the risk level of the program including the module by the program execution system, and assign a signature to the module. However, if a module without signature is nevertheless input by mistake, it is desirable to prevent any accident by setting the risk level of the module to the maximum value which the module can have.

Next, the risk level determining device 012 compares the value of the variable “MaxLevel” with the value of the variable “Level”. If the variable “Level” has a larger value, the risk level determining device 012 assigns the value of the variable “Level” to the variable “MaxLevel” (step S7).

Then, if the program input device 011 has not read the program to the last, the verification apparatus 010 returns to step S2 (step S8). If the program input device 011 has read the program to the last, the risk level determining device 012 transmits the variable “MaxLevel” to the verification result output device 015. The verification result output device 015 regards the value of the variable “MaxLevel” received from the risk level determining device 012 as the program risk level, and outputs a verification result I3 including the program risk level. Signature is performed based on the value of the variable “MaxLevel” (verification result I3) (step S9).

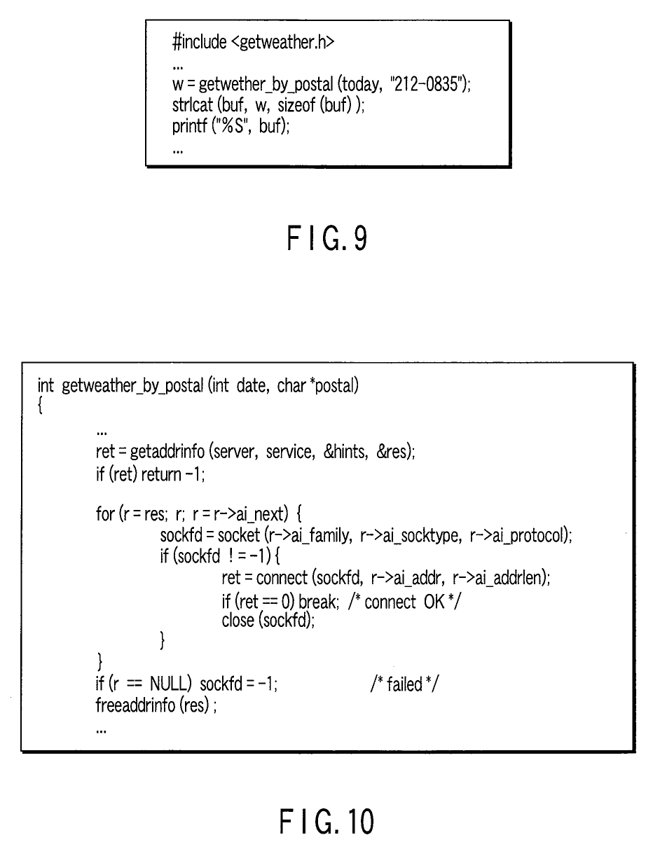

As described above, according to the verification apparatus 010, the risk level of a program can be determined by mechanically verifying the program. FIG. 9 illustrates an example of a source code of a to-be-verified program. This program uses a module “getweather_by_postal”. This module is a signed module which is not included in the table (statement risk level data: Table 1) of built-in statements. FIG. 10 illustrates an example of a source code of the signed module “getweather_by_postal”.

The verification apparatus 010 may be configured to include an additional mechanism for exception determination, to revise, for convenience's sake, verification results of programs (for example, the program illustrated in FIG. 10 includes “socket” and thus the risk level thereof is determined as “5”) which are useful but is determined as having a large risk level value by mechanical verification (for example, the risk level of the program illustrated in FIG. 10 is revised to “2”). As an example of a specific revising method, a plurality of program patterns which are known as having low risk levels are stored in advance, and the risk level is revised by comparing the program patterns with the input program or tracking and analyzing relationship between variables in the program.

The verification apparatus 010 can also be realized by using, for example, a general-purpose computer apparatus as basic hardware. Specifically, the program input device 011, the risk level determining device 012, the statement risk level storage 013, the module risk level determining device 014, and the verification result output device 015 can be realized by executing programs by the processor installed in the computer apparatus. In this case, the verification apparatus 010 may be realized by pre-installing the programs in the computer apparatus. Further, the verification apparatus 010 may be realized by installing the programs, which are stored in storage media such as CD-ROMs or distributed through networks, in the computer apparatus. Furthermore, the programs can be realized by using a memory or a hard disk internal or external to the computer apparatus, or storage media such as CD-Rs, CD-RWS, DVD-RAMs, and DVD-Rs.

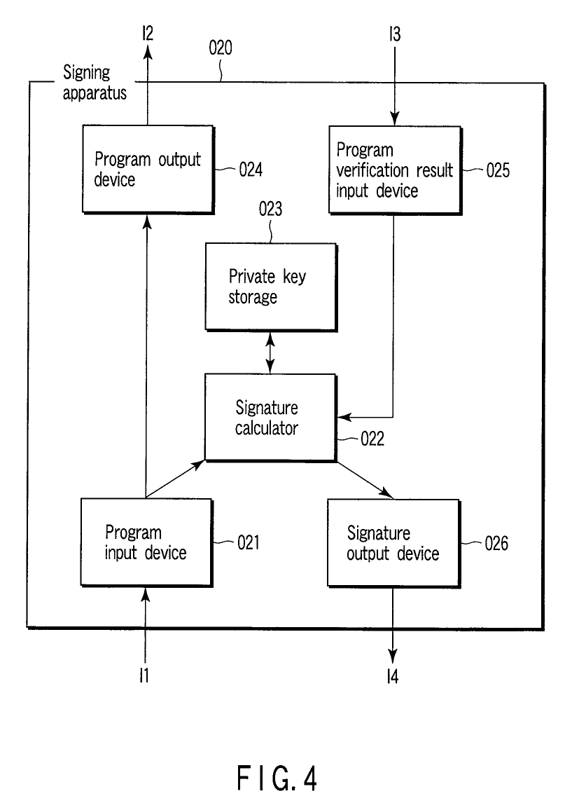

Referring to FIG. 4, the signing apparatus 020 includes a program input device 021 which inputs a to-be-verified program I1 transmitted from the development apparatus 030, a signature calculator 022 which calculates a signature to be added to the to-be-verified program I1, a private key storage 023 which stores private keys necessary for signature, a program output device 024 which outputs the to-be-verified program I2 to the verification apparatus 010, a program verification result input device 025 which input the verification result I3 transmitted from the verification apparatus 010, and a signature output device 026 which outputs a signature I4 to the development apparatus 030.

Operation of the signing apparatus 020 is explained with reference to FIGS. 4 and 8. First, the program input device 021 reads the to-be-verified program I1 transmitted from the development apparatus 030, and transmits the program I1 to the program output device 024 and the signature calculator 022. The program output device 024 outputs the to-be-verified program I1 to the verification apparatus 010 without any processing, and requests the verification 010 to verify the output to-be-verified program I2.

Next, the program verification result input device 025 receives the program verification result I3 transmitted from the verification apparatus 010, and transmits the result I3 to the signature calculator 022. The signature calculator 022 calculates (generates) a signature to be added to the to-be-verified program I1 received from the program input device 021, on the basis of the program verification result I3 received from the program verification result input device 025, a private key read from the private keys stored in the private key storage 023, and a verifier profile relating to the signing apparatus 020.

Calculation of a signature is explained with reference to FIG. 8 illustrating an example of a data structure of a signed program.

A verifier signature object 105 is formed by connecting a verifier profile 102, a program risk level 103 (program verification result I3) and the program 104 (to-be-verified program I1). The verifier signature object 105 is subjected to one-way hash function operation, and an output of the operation is encrypted by using the private key. The encrypted output is used as a verifier signature (digital signature) 101. A signature I4 is obtained by connecting the verifier signature 101, the verifier profile 102, and the program risk level 103.

The verifier profile 102 can include a verifier's ID, a verifier's name, a digital certificate, hash function algorithm, digital signature algorithm, a serial number, a time stamp, a valid period, and a random number, etc. The verifier profile 102 may be also stored in the private key storage 103 in advance. Further, if the random number is included in the verifier profile, a random number generator may be included in the signing apparatus 020. If the time stamp is included in the verifier profile, a clock to obtain the current time of day may be included in the signing apparatus 020. The one-way hash function can be formed by using hash function algorithm such as SHA256, or private key encryption algorithm such as AES. Further, the digital signature can be formed by using RSA public key encryption algorithm or elliptic curve cryptosystem algorithm. The signature calculator 022 transmits the calculated signature I4 to the signature output device 026. The signature output device 026 transmits the signature I4 to the development apparatus 030.

As described above, the signing apparatus 020 enables generation of signatures according to the risk level of the program verified by the verification apparatus 010.

The signing apparatus 020 can be realized by, for example, using a general-purpose computer apparatus as basic hardware. Specifically, the program input device 021, the signature calculator 022, the private key storage 023, the program output device 024, the program verification result input device 025, and the signature output device 026 can be realized by executing programs by the processor installed in the computer apparatus. In this case, the signing apparatus 020 may be realized by pre-installing the programs in the computer apparatus. Further, the signing apparatus 020 may be realized by installing the programs, which are stored in storage media such as CD-ROMs or distributed through networks, in the computer apparatus. Furthermore, the programs can be realized by using a memory or a hard disk internal or external to the computer apparatus, or storage media such as CD-Rs, CD-RWs, DVD-RAMs, and DVD-Rs.

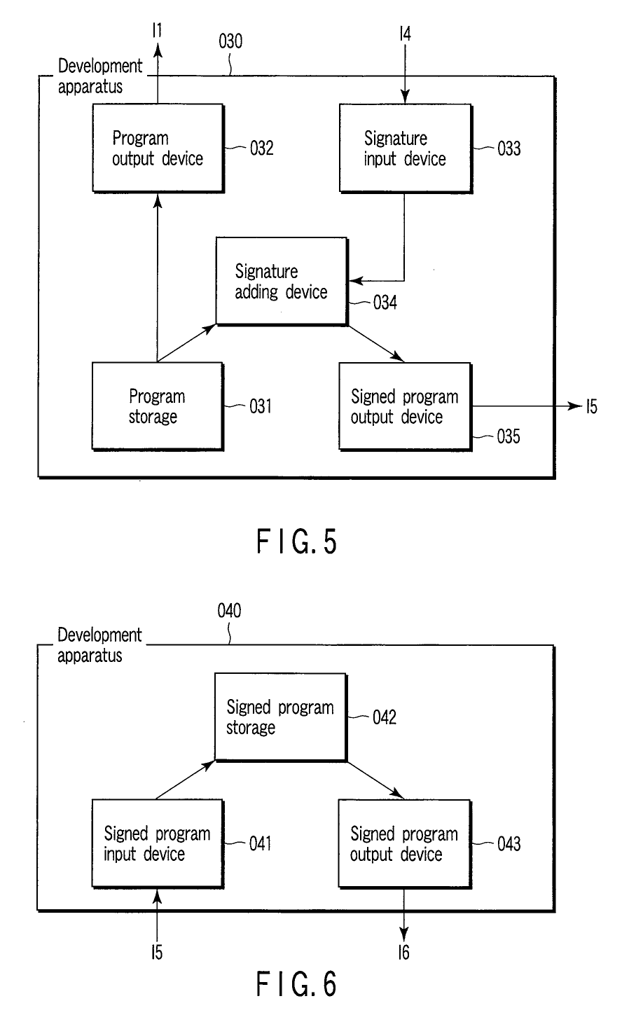

Referring to FIG. 5, the development apparatus 030 includes a program storage 031 which stores the to-be-verified program I1, a program output device 032 which outputs the to-be-verified program I1, a signature input device 033 which inputs the signature I4 transmitted from the signing apparatus 020, a signature adding device 034 which adds the signature I4 to the to-be-verified program I1, and a signed program output device 035 which outputs a signed program I5.

Operation of the development apparatus 030 is explained with reference to FIG. 5.

The program storage 031 stores to-be-verified program I1 which has been developed and tested, and is to be verified in advance before being subjected to use by the user apparatus 050. The program storage 031 transmits the to-be-verified program I1 to the program output device 032 and the signature adding device 034. The program output device 032 transmits the to-be-verified program I1 to the signing apparatus 020, and requests the signing apparatus 020 to generate a signature to be added to the to-be-verified program I1. The signature input device 033 receives a signature I4 transmitted from the signing apparatus 020, and transmits the signature I4 to the signature adding device 034. The signature adding device 034 adds the signature I4 received from the signature input device 033 to the to-be-verified program I1 received from the program storage 031, and transmits a generated signed program I5 to the signed program output device 035. The signed program I5 has a data structure as illustrated in FIG. 8. Then, the signed program I5 transmits the signed program I5 to the distribution apparatus 040. The development apparatus 030 having the above structure requests the signing apparatus 020 to perform verification and generate a signature when a new program is developed, and thus a signed program I5 can be easily prepared.

The development apparatus 030 can be realized by, for example, using a general-purpose computer apparatus as basic hardware. Specifically, the program storage 031, the program output device 032, the signature input device 033, the signature adding device 034, and the signed program output device 035 can be realized by executing programs by the processor installed in the computer apparatus. In this case, the development apparatus 030 may be realized by pre-installing the programs in the computer apparatus. Further, the development apparatus 030 may be realized by installing the programs, which are stored in storage media such as CD-ROMs or distributed through networks, in the computer apparatus. Furthermore, the programs can be realized by using a memory or a hard disk internal or external to the computer apparatus, or storage media such as CD-Rs, CD-RWs, DVD-RAMs, and DVD-Rs.

Referring to FIG. 6, the distribution apparatus 040 includes a signed program input device 041 which inputs the signed program I5, a signed program storage 042 which stores the signed program I5, and the signed program output device 043 which outputs the signed program I5 for distribution to the user apparatus 050.

Operation of the distribution apparatus 040 is explained with reference to FIG. 6. First, the signed program input apparatus 041 receives the signed program I5 from the development apparatus 030, and transmits the signed program I5 to the signed program storage 042. The signed program storage 042 stores the signed program I5, and transmits the signed program I5 to the signed program output device 043. The signed program output device 043 transmits the signed program I5 to the user apparatus 050 through, for example, a communication line, in response to a distribution request from the user apparatus 050. The distribution apparatus having the above structure enables reception and storage of the signed program I5 from the development apparatus 030, and distribution of the signed program I5 to the user apparatus 050.

The distribution apparatus 040 can be realized by, for example, using a general-purpose computer apparatus as basic hardware. Specifically, the signed program input device 041, the signed program storage 042, and the signed program output device 043 can be realized by executing programs by the processor installed in the computer apparatus. In this case, the distribution apparatus 040 may be realized by pre-installing the programs in the computer apparatus. Further, the distribution apparatus 040 may be realized by installing the programs, which are stored in storage media such as CD-ROMs or distributed through networks, in the computer apparatus. Furthermore, the programs can be realized by using a memory or a hard disk internal or external to the computer apparatus, or storage media such as CD-Rs, CD-RWs, DVD-RAMs, and DVD-Rs.

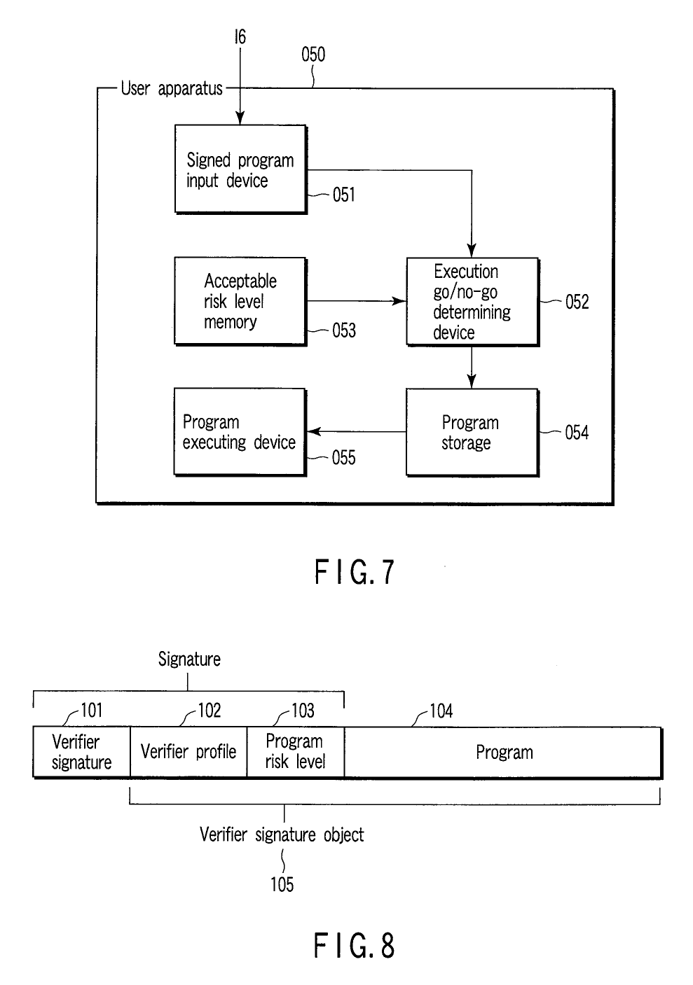

Referring to FIG. 7, the user apparatus 050 includes a signed program input device 051 which inputs the signed program I5, an execution go/no-go determining device 052 which determines whether to execute or not to execute the signed program I5, an acceptable risk level memory 053, a signed program storage 054 which stores the signed program I5, and a signed program executing device 055 which executes the signed program I5.

Operation of the user apparatus 050 is explained with reference to FIG. 7. First, the signed program input device 051 receives the signed program I5 from the distribution apparatus 040, and transmits the signed program I5 to the execution go/no-go determining device 052. The execution go/no-go determining device 052 reads the executable risk level stored in the acceptable risk level memory 053, compares the signature I4 added to the signed program I5 transmitted from the signed program input device 051 with the executable risk level, and determines whether the program can be executed or not. When the program risk level written in the signature I4 does not exceed the executable risk level, the execution go/no-go determining device 052 transmits the signed program I5 to the signed program storage 054. The signed program execution device 055 reads the signed program I5 from the signed program storage 054, and executes the signed program I5. As described above, according to the user apparatus 050, it is possible to receive the signed program I5 from the distribution apparatus 040, and store and execute the program having a risk level not exceeding the executable risk level.

The user apparatus 050 can be realized by, for example, using a general-purpose computer apparatus as basic hardware. Specifically, the signed program input device 051, the execution go/no-go determining device 052, the acceptable risk level memory 053, the signed program storage 054, and the signed program executing device 055 can be realized by executing programs by the processor installed in the computer apparatus. In this case, the user apparatus 050 may be realized by pre-installing the programs in the computer apparatus. Further, the user apparatus 050 may be realized by installing the programs, which are stored in storage media such as CD-ROMs or distributed through networks, in the computer apparatus. Furthermore, the programs can be realized by using a memory or a hard disk internal or external to the computer apparatus, or storage media such as CD-Rs, CD-RWs, DVD-RAMs, and DVD-Rs.

Variations of the above embodiment are explained below.

### Variation 1

The user apparatus 050 may have a mechanism to invalidate the signature I4, in preparation for cases where it is turned out later that the program has vulnerability or exhibits dangerous behavior. In this case, the user apparatus 050 is provided with a separate storage which stores revoked signatures. The execution go-no-go determining device 052 of the user apparatus 050 refers to the revoked signatures stored in the revoked signature storage, and determines whether the signature of the signed program to be executed corresponds to any of the revoked signatures.

### Variation 2

The storage storing revoked signatures may add revoked signatures to the stored revoked signatures, on receiving revocation notifications (incident reports) from the signing apparatus 020, the development apparatus 030, and the distribution apparatus 040. Further, the storage may add revoked signatures, on receiving revocation notifications from other reliable certification systems.

### Variation 3

In the above embodiment, the risk level determining device 012 calculates the program risk level such that the program risk level is set to the maximum value of the risk levels of the built-in statements and signed modules included in the to-be-verified program (see FIG. 3). However, the program risk level may be determined by the sum or the average of the risk levels, or a combination thereof with other indexes. Further, the value of the risk level may be corrected according to the manufacturer of the program. For example, the risk levels of programs manufactured by programmers registered in advance in the verification apparatus 010 may be reduced by 1, and the risk levels of programs manufactured by anonymous programmers may be increased by 1.

### Variation 4

In the above embodiment, the signing apparatus 020 transmits the signature I4 to the development apparatus 030, and the development apparatus 030 generates the signed program I5 corresponding to the to-be-verified program I1 with the signature I4, and transmits the signed program I5 to the distribution apparatus 040 (see FIG. 1). However, the signing apparatus 020 may generate the signed program I5 by adding the signature I4 to the to-be-verified program I1, and transmit the signed program I5 to the distribution apparatus 040 directly (without through the development apparatus 030).

According to embodiments described above, it is possible to verify the risk levels of programs which access important resources such as networks. Such verified programs are distributed with signatures, and only signed programs are allowed to be executed in user apparatuses. Therefore, it is possible to suppress the opportunity of executing malware and computer viruses in user apparatuses.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A program verification apparatus comprising:
a storing device to store a plurality of statements in correspondence with values of respective risk levels of the statements;
an obtaining device configured to refer to a signature included in a signed module, and thereby to obtain a value indicating a risk level of the signed module;
an input device configured to input a to-be-verified program including a plurality of statements or signed modules;
a calculating device configured to determine values of first risk levels of the statements included in the to-be-verified program by referring to the storing device, determine values of second risk levels of the signed modules included in the to-be-verified program by using the obtaining device, and calculate a maximum value of a risk level of the to-be-verified program from the values of the first risk levels and the values of the second risk levels; and
an output device configured to output a verification result including the maximum value of the risk level.

2. The apparatus according to claim 1, wherein
the calculating device calculates a combination of a sum or an average of the risk levels with other indexes, as a value of the risk level of the to-be-verified program, instead of the maximum value; and
the output device outputs a verification result including the value of the risk level of the to-be-verified program.

3. The apparatus according to claim 1, further comprising:
means for correcting the values of the first risk levels or the values of the second risk levels according to manufacturer of the program.

4. A signature system having a program verification apparatus recited in any one of claims 1 to 3, the system comprising:
a first input device configured to input a to-be-verified program;
a first output device configured to output the to-be-verified program to the program verification apparatus;
a second input device configured to input a verification result output from the program verification apparatus with respect to the to-be-verified program output by the first output device;
a first generating device configured to generate signature information including the verification result input to the second input device; and
a second generating device configured to generate a signed program by adding the signature information to the to-be-verified program input to the first input device.

5. A signature system according to claim 4, further comprising:
a distribution device configured to distribute the signed program generated by the second generating device, in response to a request from a user apparatus which uses the signed program.

6. A signature system according to claim 4, wherein
the first generating device includes:
a calculating device configured to form a verifier signature object by connecting a verifier profile, the verification result output from the program verification apparatus, and the to-be-verified program input to the first input device, and calculate a one-way hash function value from the verifier signature object; and
a third generating device configured to generate a verifier signature by encrypting the one-way hash function value by using a private key,
and the first generating device generates the signature information by connecting the verifier information, the verifier profile, and the verification result output from the program verification apparatus.

7. A program verification method comprising: storing a plurality of statements in correspondence with values of respective risk levels of the statements by a storing device;
referring to a signature included in a signed module, and thereby obtaining a value indicating a risk level of the signed module by an obtaining device;
inputting a to-be-verified program including a plurality of statements or signed modules by an input device;
determining values of first risk levels of the statements included in the to-be-verified program by referring to the storing device, determining values of second risk levels of the signed modules included in the to-be-verified program by using the obtaining device, and calculating a maximum value of a risk level of the to-be-verified program from the values of the first risk levels and values of the second risk levels by a calculating device; and
outputting a verification result including the maximum value of the risk level by an output device.
